(19) United States
(12) Patent Application Publication
(10) Pub. No.: US 2005/0176441 A1
(43) Pub. Date: Aug. 11, 2005

(54) Method and apparatus for locating mobile stations in a wireless telecommunications system

(76) Inventor: Joseph W. Jurecka, McKinney, TX (US)

Correspondence Address: NORTEL NETWORKS CORPORATION;INTELLECTUAL PROPERTY LAW GROUP, P O BOX 832130, RICHARDSON, TX, 750832130, US

(21) Appl. No.: 10/774,152

(22) Filed: Feb. 6, 2004

(51) Int. Cl. H04M 11/04

(52) U.S. Cl. 455/456.1; 455/404.1

(57) ABSTRACT

A method for determining the location of a mobile station/cell phone making a call that may be an emergency 911 call. When the call is originated at the mobile station, the supporting wireless network receives data from a GPS device built into the mobile station as to the latitude and longitude of the device making the call. In addition, the mobile station transmits a barometric pressure measurement that allows the wireless support network to determine the altitude of the mobile station at the latitude and longitude reported by the mobile station. With that information in hand, the location of the mobile station making the emergency including its altitude relative to ground level at the mobile station's latitude and longitude can readily be determined.

### BACKGROUND OF THE INVENTION

1. Field of the Invention

The present invention relates to the field of wireless telecommunications and particularly to the problem of locating mobile stations being served by a wireless telecommunications system.

2. Description of the Prior Art

In the area of wireless telecommunications, many problems exist with respect to locating a given mobile station being served by a wireless network, particularly, though not limited to, emergency or “911” calls. Various methods for locating a given mobile station have been proposed including utilizing GPS technology in the mobile itself or to use the capability of the network itself to determine where the given mobile is located by measuring, for example, round trip delay from a base station to a given mobile and back.

The foregoing methods for locating a given mobile station have proved quite successful in locating the mobile from a latitude and longitude point of view. The utilization of GPS technology clearly is capable of more accurately locating the mobile than network based approaches but it does have the drawback of requiring a GPS chip set in the mobile itself. As the cost and physical size of this technology continues to drop, this drawback has become a smaller deterrent to its being adopted. However, these approaches have not been very successful in locating the mobile station in question from a vertical point of view. While this may not be critical in most locations, it becomes very important when the caller being located is in a multi-story building located at the latitude and longitude determined for the caller.

In view of the above mentioned problem of being unable to accurately locate a mobile station in a vertical direction, what is needed is the ability for a wireless network to locate mobile stations during emergency calls or otherwise from a latitude, longitude and altitude point of view.

### SUMMARY OF THE INVENTION

The present invention provides a method and apparatus for accurately locating a mobile station. According to the present invention, a mobile station, making an emergency call or another type of call where the location of the calling party is desired, is sent a location query from the base transceiver station of the network supporting the call to request return data indicating the latitude, longitude and altitude of the given mobile station making the call. In the preferred embodiment of this invention, the given mobile determines latitude and longitude information with a global positioning satellite (GPS) chip set installed in the mobile station. This technology is utilized in a conventional manner and the data is transmitted from the mobile station to the base transceiver station in response to the location query. In addition, the mobile station is equipped with a barometric pressure transducer and the barometric pressure at the mobile station is also transmitted to the base transceiver station in response to the location query.

The base station transceiver or some other network control element can then determine where the given mobile station in question is located. From a barometric pressure sensor located at the base station transceiver or some other suitable location, the difference in barometric pressure between the known location of the barometric pressure sensor at the base station and that at the location of the given mobile station is measured. In addition, by a table look-up, the altitude of the ground at the latitude and longitude of the given mobile station is determined as well as the altitude of the barometric transducer at the base station transceiver. With this information, the altitude of the mobile station at its latitude and longitude can be determined thereby providing the vertical location of a mobile station making a call.

### BRIEF DESCRIPTION OF THE DRAWINGS

FIG. 1 is an illustration showing the relative positioning of a mobile station relative to a base station transceiver;

FIG. 2 schematically illustrates the components needed for locating the mobile station; and

FIG. 3 illustrates the method for utilizing the components to provide a location for the mobile station in terms of latitude, longitude and altitude.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

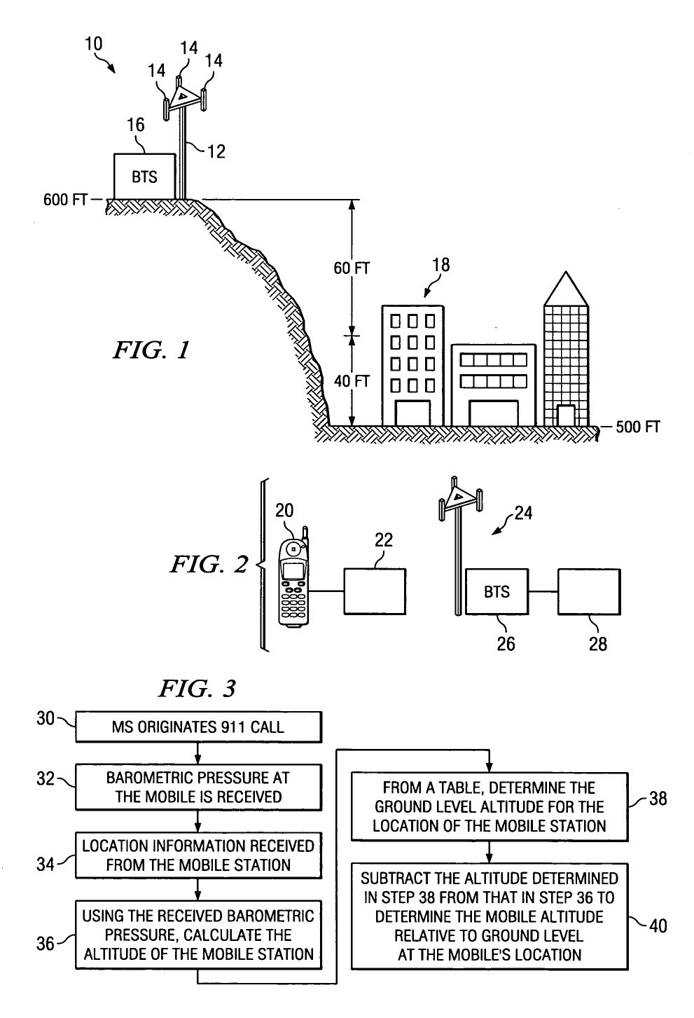

Referring now to FIG. 1, a base transceiver station (BTS) is illustrated generally at 10. The BTS 10 includes a tower 12 with a plurality of directional antennas 14 positioned on top of the tower 12 to provide radio coverage for a plurality of sectors. As the illustrated BTS 10 has 3 antennas 14, each antenna is positioned so as to provide radio coverage over a unique sector 120 degrees wide with an apex disposed at the tower 12. It is to be noted that the number of sectors covered by this antenna arrangement is not critical but is merely representative. Other typical coverage arrangements can be for single sector, two sectors, 6 sectors etc.

At the base of the tower 12 is a structure 16 (labelled BTS) that houses most of the electronics at the BTS 10. It also is connected by telephony interconnect cables with other elements of the wireless telecommunications network in which the invention is deployed. These interconnect cables have various well known functions.

As will become clearer from the discussion that follows, a barometric pressure sensor (not shown) for measuring barometric pressure is located within the BTS structure 16. The exact elevation of the BTS 12 is determined and for purposes of this illustration is assumed to be 600 feet above mean sea level. The altitude of the BTS 12 is a reference altitude for determining the altitude of mobile stations in the coverage area of the BTS 12.

FIG. 1 also has a building 18 located some distance from the BTS 12. For purposes this discussion, this building is assumed to stories 7 stories tall. It is located at a point within the wireless telephone coverage area of BTS 12 at a base elevation of 500 feet. If a mobile station (not shown) were used by a subscriber to the service provided by BTS 12 from within the fourth floor of building 18, the subscriber would be located at an elevation of approximately 40 feet above the base elevation of the building and 60 feet below the elevation of the BTS 12.

Various techniques can be utilized to determine the location of a mobile station operating on the fourth floor of building 18. For example, one technique involves using round trip delay for signals coming from the base transceiver station 12 going to and returning from the mobile on the fourth floor. This round trip delay can be calculated by the BTS 12 and converted using a table into a distance between the BTS 12 and the mobile on the fourth floor of building 18. By making the same calculation with respect to one or more other BTS not shown, the intersection of circles on a map centered at the respective base stations having a radius equal to the distance of the mobile station from the BTS will define a region close to the location of the mobile station. Even greater accuracy in determining the location of the mobile station can be achieved if the mobile station is equipped with a GPS device designed to determine the exact latitude and longitude of the GPS antenna. Either or a combination of both methods will serve with greater or lesser accuracy to identify that the mobile station is located within the building 18. Therefore, for high rise buildings such as building 18 there is a need to accurately determine the altitude of the mobile station if emergency 911 calls are to be able to accurately direct emergency support personnel to the location of the mobile station making the emergency call.

To achieve the required accuracy in locating a mobile station both by latitude and longitude and altitude, the present invention contemplates utilizing barometric sensors at both the BTS location and at the mobile station supported thereby. By locating a barometric sensor (not shown) at the BTS 12, the wireless telecommunications system can periodically sense the air pressure at the BTS 12. Since air pressure varies in a generally known fashion with respect to the altitude, if one were to rise 100 feet above the location of the BTS 12, the air pressure would fall a predictable amount. The same can be said for the change in air pressure if one were to leave BTS 12 and go down the hill to the ground level of building 18 only in this case the air pressure would rise. Thus, by noting the difference in the air pressure at the mobile station and the air pressure at the nearby BTS 12, the network can determine the relative altitude difference between the BTS 12 and the location of the mobile station thereby permitting persons responding to a 911 emergency call to better judge where, in a high rise building, the call has come from once they determine that the call has come from a high rise building.

FIG. 2 illustrates schematically the electronic circuitry needed to provide the elevation of a mobile station making an emergency 911 call relative to the elevation of the BTS supporting the mobile station. A mobile station or cell phone 20 has a barometric pressure transducer 22 coupled thereto. The exact transducer 22 is not critical here though it is desirable to be small enough to be housed within the cell phone 20 as having a separate housing is undesirable. Transducers of a type suitable for this application have been utilized in digital watches and the like to determine the altitude of the user.

FIG. 2 illustrates the antenna structure 24 at a typical Base Transceiver Station (BTS) that has electronics 26 for producing the radio wave signals for communicating between the BTS and the cell phone 20. The electronics 26 has a barometric pressure sensing transducer 28 coupled thereto to permit the network coupled thereto to measure the barometric pressure at the base of the antenna structure 24. Accordingly, with barometric pressure sensing transducers being located at the BTS and at the mobile station, the needed hardware is provided so that the relative barometric pressure difference between the barometric pressure at the mobile station and at the base station transceiver can be determined so that if an emergency 911 call is made by the mobile station, the altitude of the mobile station can be determined.

FIG. 3 illustrates the method for determining the location of the mobile station when an emergency 911 call or the like is originated by the user as illustrated by step 30. In response to origination of such an emergency call, the local wireless support network couples the mobile subscriber initiating the emergency call to a local emergency call center. During that process, the mobile station sends its location in terms of latitude and longitude which is generated by a GPS device located within the mobile station itself. The mobile station also sends the barometric pressure measured at the hand set to the local wireless support network. The network receives the barometric pressure data as illustrated by step 32 and the latitude and longitude information as illustrated at step 34. Those of skill in the art will realize that the order in which the pressure and latitude/longitude data is received is not critical. It is also not critical as to the form of the message (short message service message) or the standards (standardized signalling between the mobile and the network) required such that the local wireless support network can properly interpret the information received from the mobile station.

Once the barometric pressure at the mobile station has been received at the local wireless support network, the difference between the barometric pressure at the mobile station and the barometric pressure at the base transceiver station is calculated. Then, as illustrated at step 36, the difference in altitude of the mobile station and the altitude of the BTS supporting the emergency call is calculated. In the next step 38, a table lookup is used to determine the ground level altitude of the mobile station based on the latitude and longitude received from the mobile station. As illustrated in step 40, the altitude of latitude/longitude of the mobile station calculated in step 38 is subtracted from the altitude of the mobile station calculated in step 36 to yield the altitude of the mobile station above the ground at the longitude/latitude reported by the mobile station assuming the calculation yielded a positive number. If the calculation in step 40 is zero or substantially zero, the mobile station is located at surface level at the latitude/longitude reported. If, however, the altitude is 40 above the surface, for example, then the mobile station is above the ground surface at the latitude/longitude reported by the mobile station and emergency support personnel at the scene can make a quick assessment as to what floor of a building the call is coming from. They may use an approximation of 10 feet for each floor of the building. If the number turns out to be negative, then the emergency call in question is doming from a phone located below grade level at the mobile's location.

While the above description has been made in connection with an advantageous embodiment of the present invention, those of skill in this art will readily recognize that modifications can be made to the described invention without departing from the spirit and scope of this invention as defined by the following claims.

1. A method for determining the location of a mobile station in a wireless telecommunication system comprising the steps of:
determining the latitude and longitude of the mobile station;
receiving data from the mobile station identifying the barometric pressure at the mobile station;
measuring the barometric pressure at a known elevation;
utilizing the measured barometric pressure and the received barometric pressure to identify the actual altitude of the mobile station;
utilizing the latitude and longitude of the mobile station to determine the altitude at ground level of the exact location of the mobile station; and
utilizing the ground level altitude at the location of the mobile station and the identified actual altitude of the mobile station to determine the altitude of the mobile station relative to ground level at the latitude and longitude of the mobile station.

2. A method for determining the physical location of an emergency call originated by a mobile station comprising the steps of:
identifying that a call originated by the mobile station is an emergency call;
receiving data from the mobile station identifying the latitude and longitude of the mobile station;
receiving data from the mobile station identifying the barometric pressure measured at the mobile station;
measuring the barometric pressure at a physical location having a known altitude;
determining the altitude of the mobile station from the measured barometric pressure and the received barometric pressure;
determining the altitude of the mobile station relative to ground level at the position of the received latitude and longitude.

3. A method for determining the altitude within a high-rise building of a cellular phone user from whom a call has been placed comprising, in combination:
receiving data from the cellular phone identifying the barometric pressure at the cellular phone;
determining the latitude and longitude of the cellular phone;
determining the altitude at ground level of the high-rise building located at said latitude and longitude where the call originated; and
determining, from the altitude at ground level and the barometric pressure at the cellular phone, the altitude of the cell phone relative to the ground level of the high-rise building from which the call originated.

4. The method in claim 3 wherein said altitude at ground level of the high-rise building where the call originated is determined by table lookup using the latitude and longitude received from the cellular phone.

5. The method of claim 2 wherein the ground level altitude at the latitude and longitude received from the mobile station is determined by table lookup.

6. The method of claim 1 wherein the ground level altitude at the latitude and longitude received from the mobile station is determined by table lookup.

7. The method of claim 1 wherein the known location where the barometric pressure is measured is a location sufficiently close to the location of the mobile station that the barometric pressure at the same altitude would be substantially the same.
